(19) United States
(12) Patent Application Publication
(10) Pub. No.: US 2013/0104170 A1
(43) Pub. Date: Apr. 25, 2013

(54) Method for Processing Electronic Television Program

(71) Applicant: Hao-Zhi Su, New Taipei City (TW)

(72) Inventor: Hao-Zhi Su, New Taipei City (TW)

(73) Assignee: AVERMEDIA TECHNOLOGIES, INC., New Taipei City (TW)

(21) Appl. No.: 13/278,298

(22) Filed: Oct. 21, 2011

(51) Int. Cl. H04N 21/482

(52) U.S. Cl. 725/40

(57) ABSTRACT

A method for processing an electronic television program that arranges a viewing schedule for a user is provided, in which the method receives an electronic television program list that includes electronic television program information, and records the electronic television program selected by the user from the electronic television program list, and receives a calendar information including at least one schedule event, and compares and determines whether a time period of the electronic television program selected by the user conflicts with a time period of the scheduled event, and generates a reminder message reminding the user of recording the electronic television program in advance or to alter the scheduled event when the time periods are in conflict.

### BACKGROUND

1. Field of Invention

The present invention relates to a method for processing an electronic television program.

2. Description of Related Art

Generally, television programs can be sequentially sent through a television channel, and these television programs are broadcast in schedules. If audiences cannot watch the television program on schedules they will miss the television programs. An analog TV does not identify a start time and an end time of a television program. If the audiences need to know the scheduled time of the television program, they need to refer to newspapers, magazines, or a web page to get it. It is inconvenient to remember the broadcast time of the television program.

On the other hand, a digital TV website often provides an electronic TV program list for a user to query TV programs, and the user can add the desired TV programs into a web calendar. However, even the user has added the TV program into the calendar, the web calendar cannot notify the user to process the TV program in advance once the TV program is in conflict with a scheduled event in the calendar. As a result, the user cannot watch the TV program on time. In addition, even if the original schedule time of the TV program is not in conflict with the scheduled event in the calendar, the altered schedule time of the TV program may be still in conflict with the schedule event, which makes the user miss or ignore the TV programs.

Therefore, there is a need for providing a new approach which can remind the user of handling the desired TV program in advance.

### SUMMARY

According to one embodiment of the present invention, a method for processing an electronic television program that arranges a viewing schedule for a user is disclosed, in which the method receives an electronic television program list that includes at least one electronic television program information, and the method records the electronic television program selected by the user from the electronic television program list, and the method receives calendar information including at least one scheduled event, and the method compares and determines whether a time period of the electronic television program selected by the user conflicts with a time period of the scheduled event, and the method generates a reminder message reminding the user of recording the electronic television program in advance or to alter the scheduled event when the time periods are in conflict.

According to another embodiment of the present invention, a method for processing an electronic television program is disclosed, in which the method arranges a viewing schedule for a user. The method derives the electronic television program from an tracing list, and determines whether a time period of the electronic television program is in conflict with a time period of a scheduled event added, and puts the electronic television program into a scheduled recording list when the time period of the electronic television program is in conflict with the time period of the schedule event added.

According to still another embodiment of the present invention, a method for processing an electronic television program is disclosed, in which the method arranges a viewing schedule for a user. The method picks out an electronic television program from a scheduled recording list, and determines whether a time period of a scheduled event to be deleted is in conflict with a time period of the electronic television program, and reminds the user of canceling scheduled recording of the electronic television program when the time period of the scheduled event to be deleted is in conflict with the time period of the electronic television program.

According to the other embodiment of the present invention, a method for processing an electronic television program is disclosed, in which the method arranges a viewing schedule for a user. The method receives an electronic television program list and calendar information, and derives a tracking list according to the calendar information, and checks whether a time period of the electronic television program in a tracking list is updated, and compares the updated time period of the electronic television program with a time period of a scheduled event contained in the calendar information when the time period of the electronic television program is updated, and determines whether the two time periods are in conflict.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of an electronic television program list according to one embodiment of the present invention;

FIG. 2 is a flowchart of a method for processing an electronic television program and arranging a viewing schedule for a user according to one embodiment of the present invention;

FIG. 3A is a flowchart of a method for processing an electronic television program and arranging a viewing schedule for a user according to one embodiment of the present invention;

FIG. 3B is a diagram of a user interface according to one embodiment of the present invention;

FIG. 4 is a flowchart of a method for processing an electronic television program and arranging a viewing schedule for a user according to another embodiment of the present invention;

FIG. 5 is a flowchart of a method for processing an electronic television program and arranging a viewing schedule for a user according to still another embodiment of the present invention; and

FIG. 6 is a flowchart of a method for processing an electronic television program and arranging a viewing schedule for a user according to the other embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The method for processing an electronic television program and arranging a viewing schedule for a user of the following embodiments can automatically collect a web calendar and can simultaneously display the electronic television program list as well as contains of the web calendar. When the user has selected a desired electronic television program, the method automatically compares/checks time periods of the desired electronic television program and a scheduled event of the web calendar in order to find out if the time periods are in conflict. If the time periods are in conflict, the method will remind the user to solve the conflict. For example, the user can make a video recording appointment such that he or she can still watch the desired electronic television program after the scheduled event, which makes the television viewing more efficient and flexible.

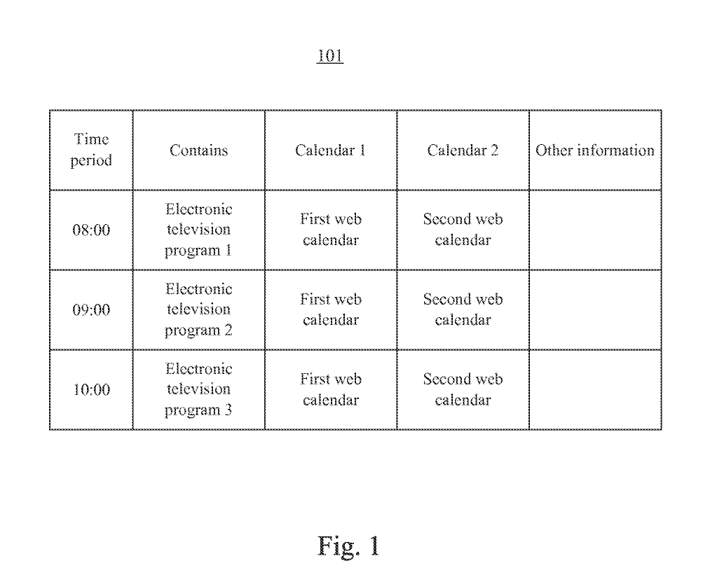

FIG. 1 is a diagram of an electronic television program list according to one embodiment of the present invention. The electronic television program list 101 provides users with information of television channel, for example, broadcast time and content if the electronic television program, which allows users to grasp the dynamic information and to plan the viewing trip in advance. The electronic television program list 101 can also provide links to web calendar, such as links to Google, Yahoo web calendar. Users can click on the icon presenting the first web calendar or the second web calendar to link to those web calendars. Next, user can join broadcast time of the electronic television program into the calendar, which facilitates users to query the broadcast time and remind users to watch the electronic television program on time.

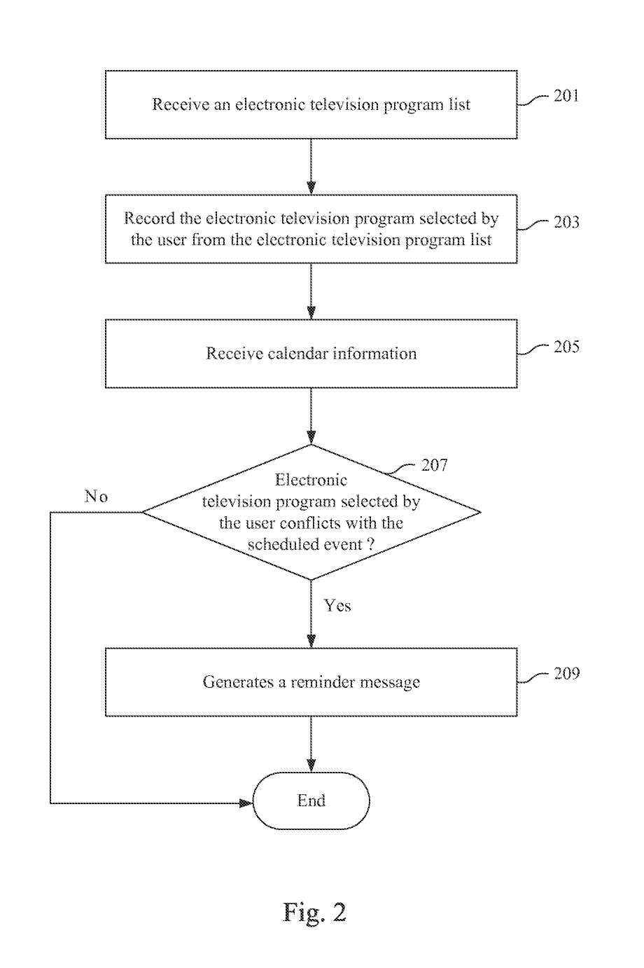

FIG. 2 is a flowchart of a method for processing an electronic television program and arranging a viewing schedule for a user according to one embodiment of the present invention. The method receives an electronic television program list that includes electronic television program information (step 201). In detail, the method can receives an electronic television program list through internet or through digital broadcasting, in which the electronic television program list includes electronic television program information such as broadcasting period and general of the electronic television program. Next, the method records the electronic television program selected by the user from the electronic television program list (step 203).

The method also receives calendar information (205) that includes at least one scheduled event. The scheduled event can be a meeting to be attended as well as corresponding time period of the meeting; the scheduled event can also be a vocation for the user. Next, the method compares and determines whether a first time period of the electronic television program selected by the user conflicts with a second time period of the scheduled event (step 207). For example, the method compares and determines whether the time period occupied by the electronic television program overlaps the time period of the meeting such that the user can not watch the electronic television program on time. When the first and second time periods are in conflict, the method generates a reminder message (step 209) reminding the user of recording the electronic television program in advance or to alter the scheduled event.

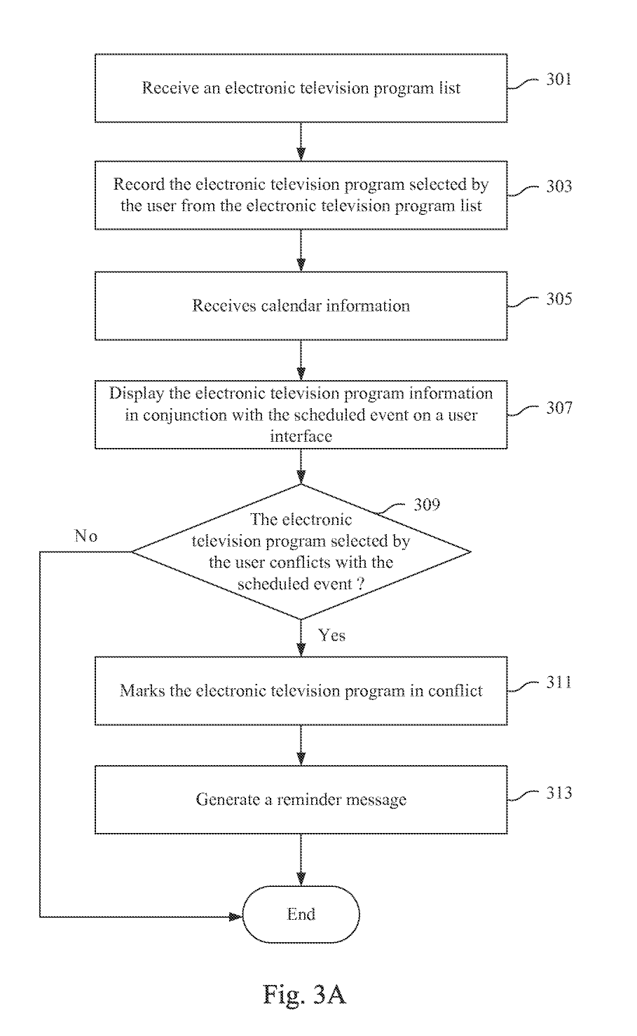

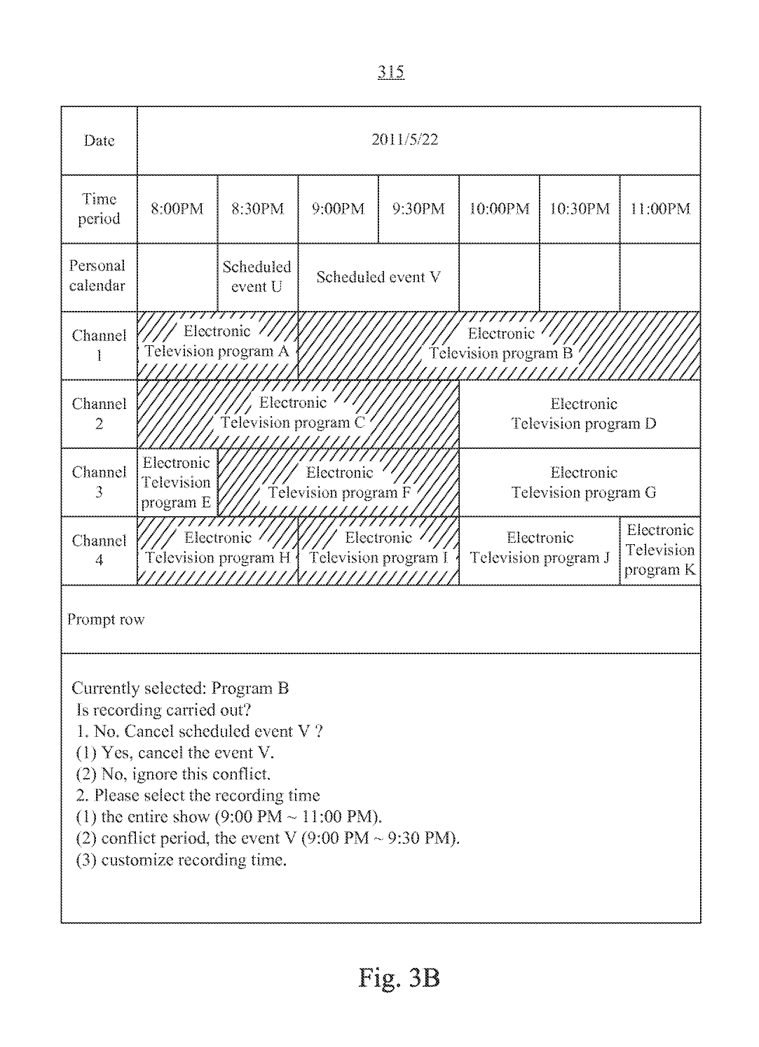

FIG. 3A is a flowchart of a method for processing an electronic television program and arranging a viewing schedule for a user according to one embodiment of the present invention while FIG. 3B is a diagram of a user interface according to one embodiment of the present invention. Similar to the embodiment shown in FIG. 2, the method of this embodiment also receives an electronic television program list (step 301) and records the electronic television program selected by the user from the electronic television program list (step 303), and the method receives calendar information (step 305). Particularly, the method in this embodiment displays the electronic television program information in conjunction with the scheduled event on a user interface (step 307) to facilitate the user for simultaneously viewing the electronic television program information and the calendar information, which is different form the method of FIG. 2.

As shown in FIG. 3B, the user interface 315 simultaneously displays the electronic television program information in conjunction with the scheduled event. Electronic television program A, electronic television program B, electronic television program C, electronic television program F, electronic television program H, and electronic television program I that are in conflict with the scheduled event U and scheduled event V are marked with shadow on the user interface 315. If the user selects the electronic television program in conflict, such as the electronic television program B, when viewing the electronic television program list, the prompt row will display the reminder message to remind the user to record the electronic television program in advance. The method can also provides the recording time for the user to refer. For instance, the method can provide the recording time for the entire show or for the time period in conflict. The user can also customize the recording time by himself.

After step 307 shown in FIG. 3A, the method continue to compare and determine whether a first time period of the electronic television program selected by the user conflicts with a second time period of the scheduled event (step 309). When the first and second time periods are in conflict, the method marks the electronic television program which is in conflict with the scheduled event on the user interface (step 311). Then the method generates a reminder message (step 313) reminding the user of recording the electronic television program in advance or to alter the scheduled event.

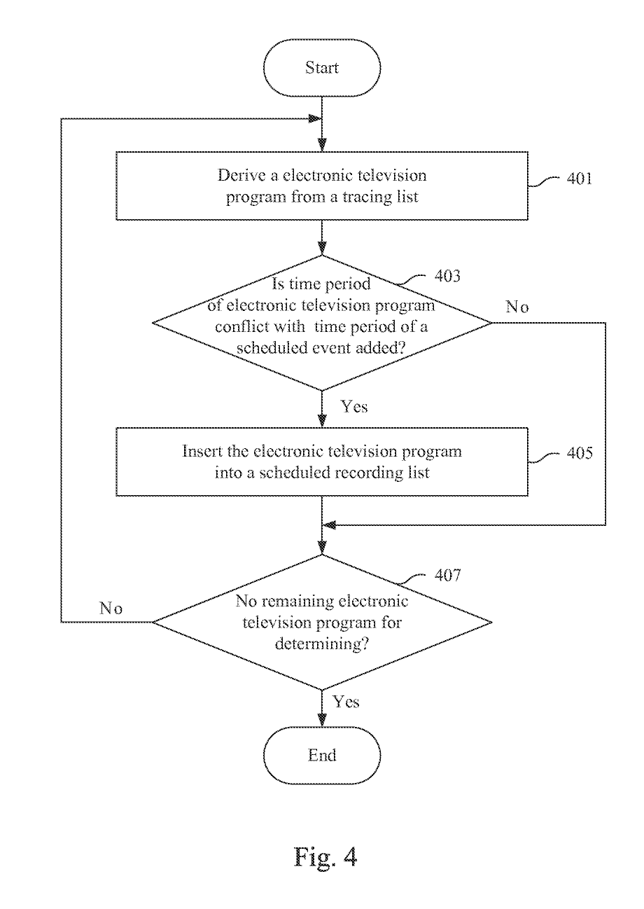

FIG. 4 is a flowchart of a method for processing an electronic television program and arranging a viewing schedule for a user according to another embodiment of the present invention. The method is used for arranging a viewing schedule for a user. The method derives the electronic television program from a tracing list (step 401) and determines whether a first time period of the electronic television program is in conflict with a second time period of a schedule event added (step 403). When the first time period of the electronic television program is in conflict with the second time period of the scheduled event added, the method inserts the electronic television program into a scheduled recording list (step 405) to remind the user to make an appointment for recording. Next, the method checks whether there is no remaining electronic television program for determining in the tracing list (step 407). If there is no remaining electronic television program for determining, the method returns to step 401 and continues to perform the remaining steps.

Particularly, the method of this embodiment let the user add the desired electronic television program into a personal calendar. When the method has received calendar information through internet, the method checks if the calendar information contains an electronic television program and merges the electronic television program contained into the tracing list. Then, the method monitors if the personal calendar is updated and compares the personal calendar updated with the tracing list in order to remind the user to make appointment for recording.

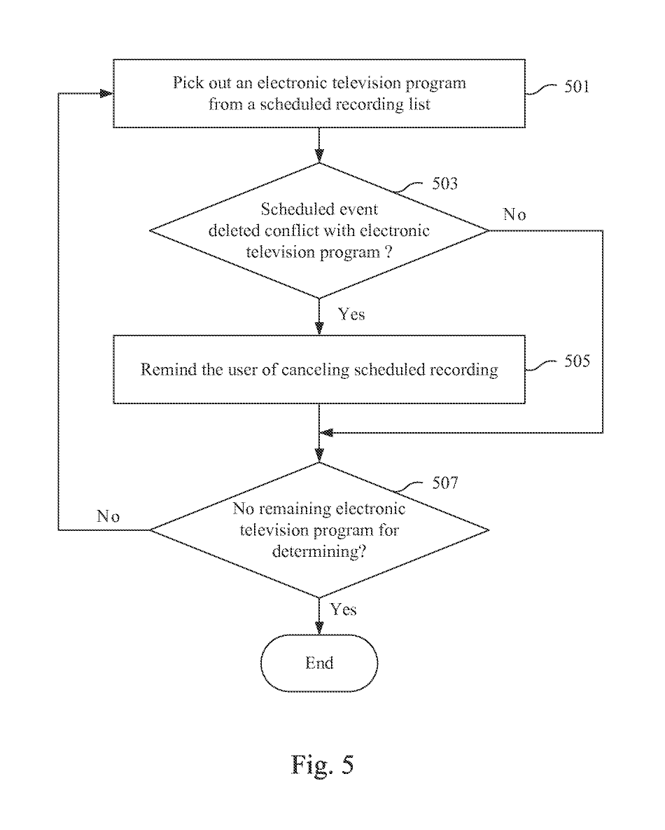

FIG. 5 is a flowchart of a method for processing an electronic television program and arranging a viewing schedule for a user according to still another embodiment of the present invention. The method picks out an electronic television program from a scheduled recording list (step 501) and determines whether a first time period of a scheduled event to be deleted is in conflict with a second time period of the electronic television program (step 503). When the first time period of the scheduled event to be deleted is in conflict with the second time period of the electronic television program, the method reminds the user of canceling scheduled recording of the electronic television program (step 505). Next, the method checks whether there is no remaining electronic television program for determining in the tracing list (step 507). If there is no remaining electronic television program for determining, the method returns to step 501 and continues to perform the remaining steps.

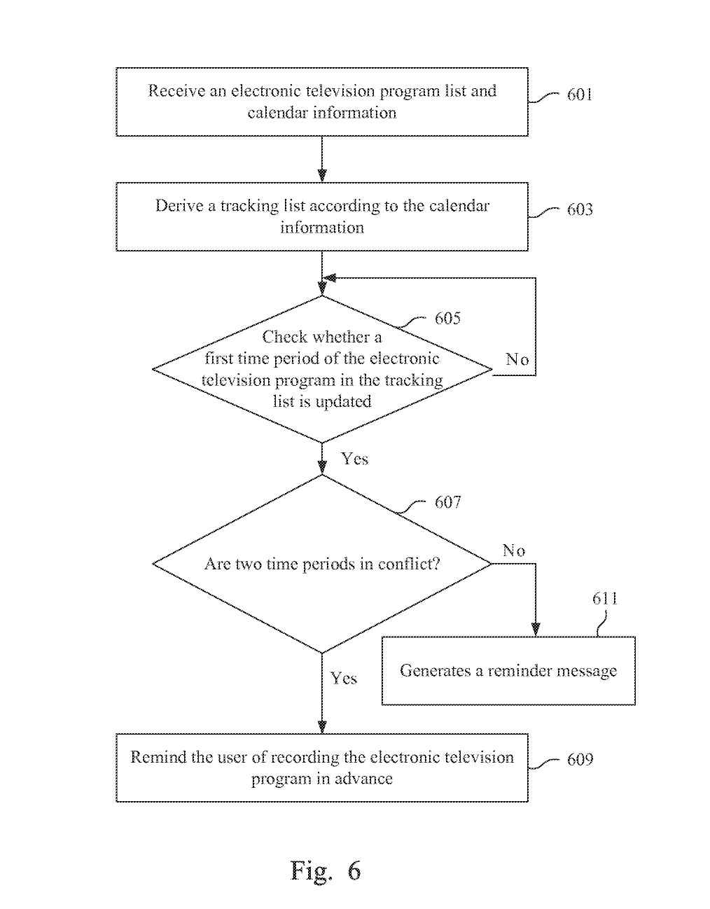

FIG. 6 is a flowchart of a method for processing an electronic television program and arranging a viewing schedule for a user according to the other embodiment of the present invention. The method receives an electronic television program list and calendar information (step 601) and derives a tracking list according to the calendar information (step 603). Next, the method checking whether a first time period of the electronic television program in the tracking list is updated (step 605). In more detail, the method checks the electronic television program list to determine if the time period of corresponding electronic television program is updated.

When the first time period of the electronic television program is updated, the method compares the first time period updated with a second time period of a scheduled event contained in the calendar information (step 607) to determine if the two periods are in conflict. When the first time period updated conflict with the second time period of the scheduled event, the method reminds the user of recording the electronic television program in advance (Step 609). On the other hand, the method generates a reminder message (step 611) to remind the user of paying attention to the first time period updated of the electronic television program when the first time period updated of the electronic television program does not conflict with the second time period of the scheduled event.

The method of the above embodiments can automatically import the calendar and shows the electronic television program as well as the contain of the calendar. When users have selected the wanted electronic television program, the method automatically compares and determines whether time period of the joined/deleted scheduled event conflicts with period of the electronic television program selected by users, and the method also remind the user to solve the conflict, such as having a scheduled recording, to prevent users from missing the wanted electronic television program.

In addition, users can also join wanted programs into tracking lists and monitor changes in the calendar. When users add or delete scheduled events from the calendar, the method compares the joined/deleted scheduled events with the program tracking list. If there is a conflict, the method reminds users of making recording appointment or canceling recording appointment. On the other hand, when the electronic television program list has been updated, the method further compares the updated time period with the time period of the scheduled event contained in the calendar if the time period of the wanted electronic television program is modified in order to check the conflicts and remind users of making recording appointment or scheduled event changing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A method for processing an electronic television program and arranging a viewing schedule for a user, the method comprising:
receiving an electronic television program list that includes electronic television program information;
recording the electronic television program selected by the user from the electronic television program list;
receiving calendar information of a web calendar, wherein the calendar information includes at least one scheduled event;
comparing and determining whether a first time period of the electronic television program selected by the user conflicts with a second time period of the scheduled event; and
generating a reminder message reminding the user of recording the electronic television program in advance or to alter the scheduled event when the first and second time periods are in conflict.

2. The method for processing the electronic television program as claimed in claim 1, further comprising:
displaying the electronic television program information in conjunction with the scheduled event on a user interface to facilitate the user for simultaneously viewing the electronic television program information and the calendar information.

3. The method for processing the electronic television program as claimed in claim 2, further comprising:
marking the electronic television program which is in conflict with the scheduled event on the user interface.

4. The method for processing the electronic television program as claimed in claim 1, wherein the electronic television program list is received through internet or through digital broadcasting.

5. A method for processing an electronic television program and arranging a viewing schedule for a user, the method comprising:
deriving the electronic television program from a tracing list;
determine whether a first time period of the electronic television program is in conflict with a second time period of a schedule event added, wherein the schedule event is included in a calendar information of a web calendar; and
inserting the electronic television program into a scheduled recording list when the first time period of the electronic television program is in conflict with the second time period of the scheduled event added.

6. The method for processing the electronic television program as claimed in claim 5, further comprising:
receiving calendar information through internet;
checking whether the calendar information contains the electronic television program; and
merging the electronic television program into the tracing list when the calendar information contains the electronic television program.

7. A method for processing an electronic television program and arranging a viewing schedule for a user, the method comprising:
picking out an electronic television program from a scheduled recording list;
determine whether a first time period of a scheduled event to be deleted is in conflict with a second time period of the electronic television program, wherein the schedule event is included in a calendar information of a web calendar; and
reminding the user of canceling scheduled recording of the electronic television program when the first time period of the scheduled event to be deleted is in conflict with the second time period of the electronic television program.

8. A method for processing an electronic television program and arranging a viewing schedule for a user, comprising:
receiving an electronic television program list and calendar information of a web calendar, wherein the calendar information includes at least one scheduled event;
deriving a tracking list according to the calendar information;
checking whether a first time period of the electronic television program in the tracking list is updated; and
when the first time period of the electronic television program is updated, comparing the first time period updated with a second time period of a scheduled event contained in the calendar information; and
determining whether the first time period updated and the second time period are in conflict.

9. The method for processing the electronic television program as claimed in claim 8, further comprising:
reminding the user of recording the electronic television program in advance when the first time period updatedof the electronic television program conflicts with the second time period of the scheduled event.

10. The method for processing the electronic television program as claimed in claim 8, further comprising:
generating a reminder message reminding the user of paying attention to the first time period updated of the electronic television program when the first time period updated of the electronic television program does not conflict with the second time period of the scheduled event.
